(19) United States
(12) Patent Application Publication
(10) Pub. No.: US 2010/0178223 A1
(43) Pub. Date: Jul. 15, 2010

(54) (Roberts) plasma waterbath

(76) Inventor: Angela Adinah Roberts, University Hts., OH (US)

Correspondence Address: Angela Adinah Roberts, 4053 Silsby Rd., University Hts., OH, 44118, US

(21) Appl. No.: 12/586,408

(22) Filed: Oct. 23, 2007

(51) Int. Cl. B01L 7/02

(52) U.S. Cl. 422/285

(57) ABSTRACT

A water bath in which a process of agitation is used. The blood, blood product, or any product that is thawed at or needs to remain heated at 25-40 degrees Celsius is used.

A new utility for a water bath as set forth in the following specification:

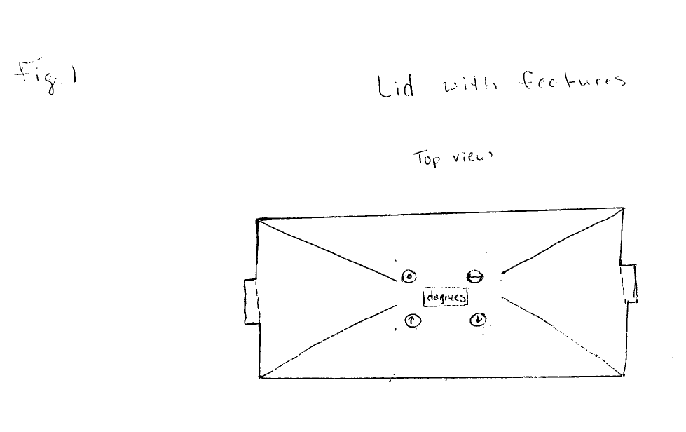

FIG. 1 is a front perspective view of the lid of the new utility;

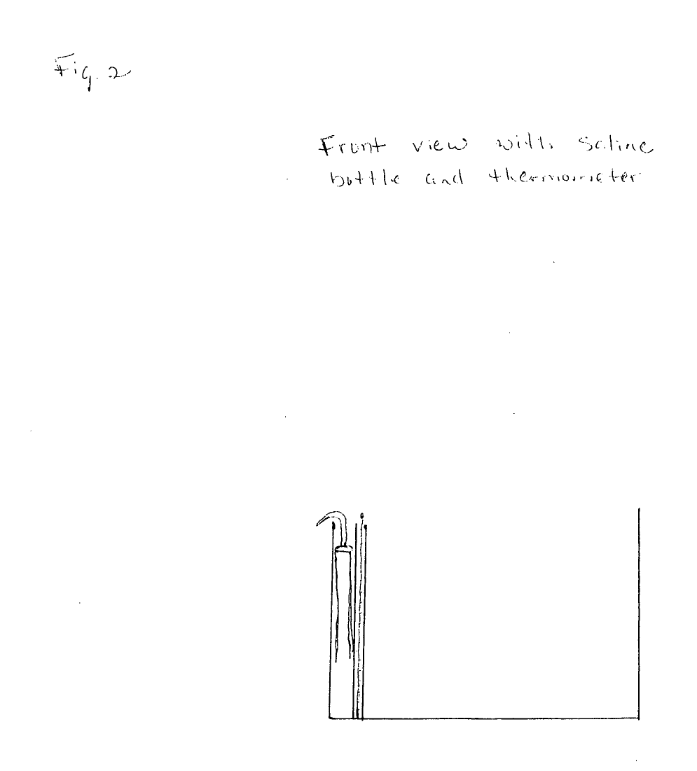

FIG. 2 is a front view of the body of the new utility;

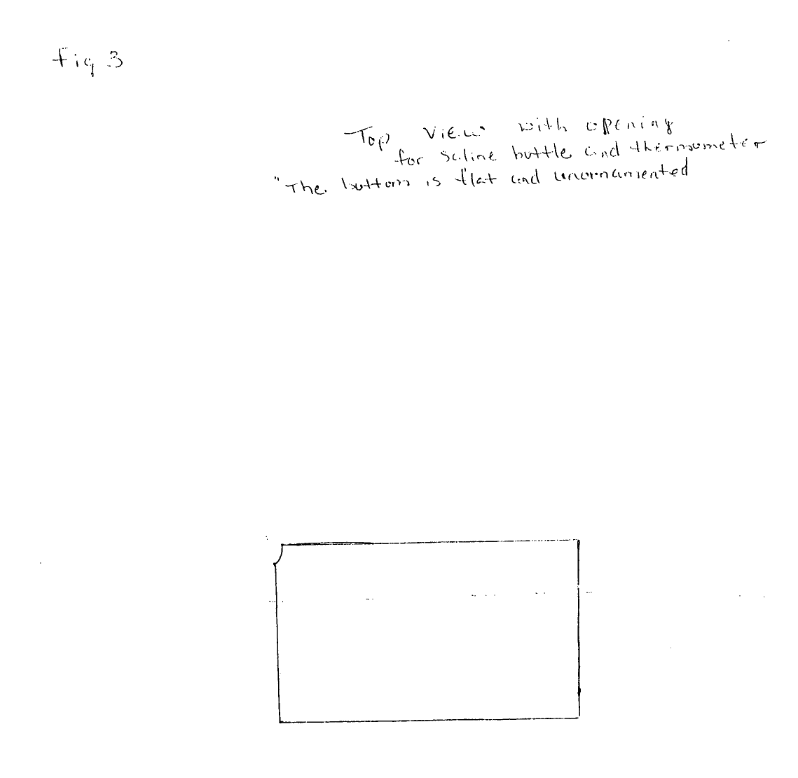

FIG. 3 is a top view of the body of the new utility;

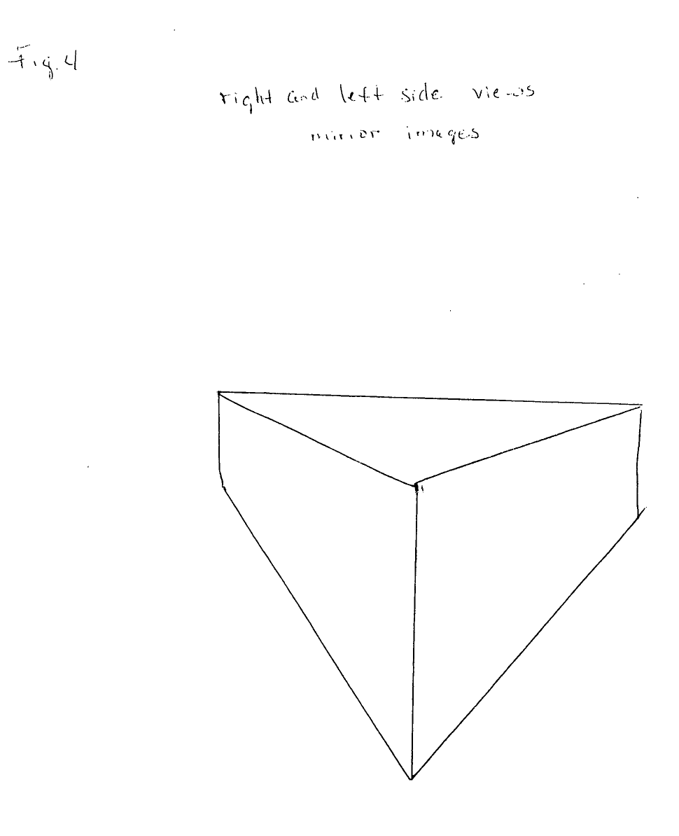

FIG. 4 is a side elevation view of the body of the new utility, the opposite that shown in FIG. 4 being the mirror image thereof;

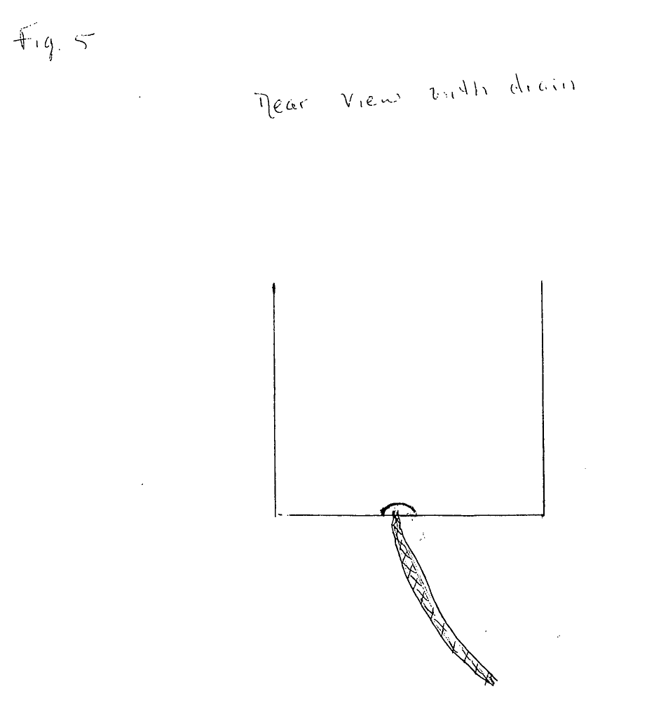

FIG. 5 is a rear perspective view of the new utility;

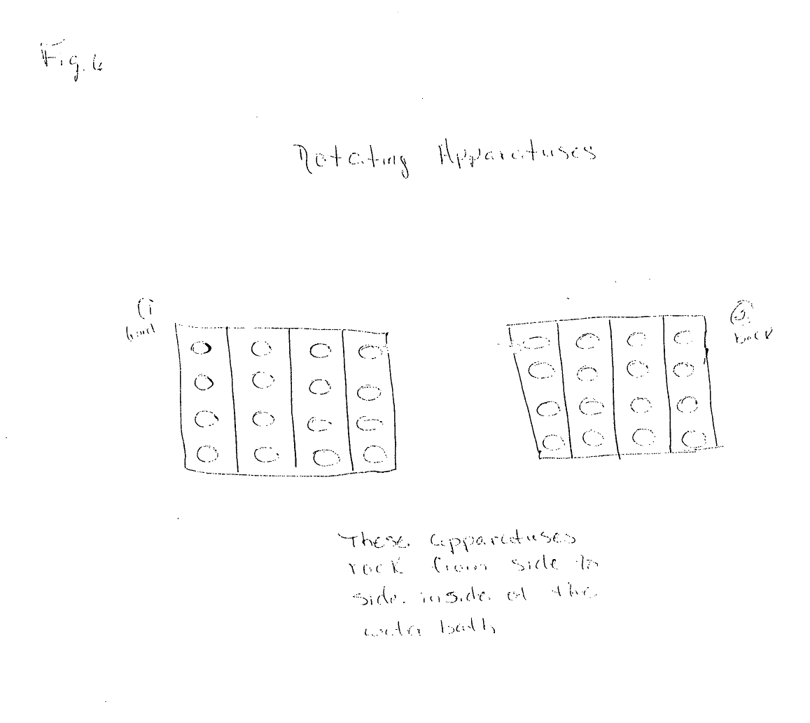

FIG. 6 is a front and side view of the rotating apparatuses; the side opposite that shown in FIG. 6 being the mirror image thereof.

No bottom view is provided since the bottom is unadorned.

The broken lines shown are for illustrative purposes and form no part of the claimed utility.

The ornamental design for a plasma water bath as shown.

1. The frozen plasma or product to be thawed or kept heated stands between two grooves inside of the water bath. The water bath agitates the product back and forth enabling it to thaw quicker. A product can sit in the water bath without agitation as well and will remain heated between 25-40 degrees Celsius as required.
